(19) United States
(12) Patent Application Publication
(10) Pub. No.: US 2017/0309149 A1
(43) Pub. Date: Oct. 26, 2017

(54) A PORTABLE ALERTING SYSTEM AND A METHOD THEREOF

(71) Applicant: Lakshya Pawan Shyam KAURA, Haryana (IN)

(72) Inventor: Lakshya Pawan Shyam KAURA, Haryana (IN)

(21) Appl. No.: 15/518,001

(22) PCT Filed: Oct. 5, 2015
(86) PCT No.: PCT/IB2015/057605

§ 371 Date: Apr. 10, 2017

(30) Foreign Application Priority Data
Oct. 10, 2014 (IN) 2904/DEL/2014

(51) Int. Cl. G08B 21/02; G06K 9/00; G08B 3/10; G08B 25/01; H04R 1/10

(52) U.S. Cl. CPC G08B 21/02; G08B 3/10; G08B 25/016; G06K 9/00697; G06K 9/00778; H04R 1/1091

(57) ABSTRACT

A system and method for detecting potential threat and alerting a user especially when the user is walking around crowded places. A portable alert system comprises a camera for taking plurality of pictures, a microphone to record the sound from surrounding, a processor to provide processing commands to the system, a repository to store required data, an image processing module to processes images captured by the camera and to determine moving objects, an audio processing module to process the sound captured by the microphone and to determine predetermined sound like siren, horn etc. and an alerting device to alert the user in case where potential threat is detected by the system.

### FIELD

The present disclosure relates to the field of alerting systems and methods.

### DEFINITIONS OF TERMS USED IN THE SPECIFICATION

The expression ‘handheld device’ used hereinafter in the specification refers to but is not limited to a mobile phone, a laptop, a tablet, a desktop, an iPad, a PDA, a notebook, a net book, a smart device, a smart phone and the like, including a wired or a wireless computing device. The handheld device is equipped with a provision to connect a headphone used to serve the purpose of listening and conversing.

### BACKGROUND

The popularity of mp3 players and smartphones for listening to music has exponentially increased worldwide. Their constant use has molded the basic human behavior of being attentive to the surroundings and makes them more susceptible to jeopardy. Whereas before the proliferation of digital devices for communication, people while walking required keeping their ears and eyes in alerting state towards the approaching threats.

It has been observed that nowadays, many people are seen walking on crowded places while staring down into their smartphones and listening to loud music or talking to other person through their handheld devices, may completely forget to take an account of the surrounding vulnerabilities. In some cases, people in the notion of hearing/talking while doing routine work, won't be able to hear or see the approaching threats like trains, vehicles and other moving objects etc. because of loud sound transmitted through the handheld devices used for listening to music or conversing. Each year, people got killed or injured because of the same reason.

Not surprisingly, these marvelous technologies relating to handheld devices has made routine work and daily life easy, however, the proliferation of handheld devices has compromised the safety of the people in some way or the other. But many of these fatalities and injuries could have been avoided if a user is alerted about the approaching danger at a right instance.

Therefore, there exists a need in the art for an alerting mechanism that will intimidate the user about the approaching threat in real time using the handheld device in crowded areas.

### OBJECTS

Some of the objects of the present disclosure aimed to ameliorate one or more problems of the prior art or to at least provide a useful alternative are described herein below:

An object of the present disclosure is to provide a system that alerts a user from moving objects.

Another object of the present disclosure is to provide a system that alerts a user by detecting the sounds of the moving objects, which may indicate menace.

Another object of the present disclosure is to provide a system that alerts a blind user from moving objects or sounds which may indicate menace.

Another object of the present disclosure is to provide a system that alerts a deaf user from moving objects or sounds which may indicate menace.

Another object of the present disclosure is to provide a system that allows a user to move securely using a handheld device equipped with a headphone in crowded places.

Other objects and advantages of the present disclosure will be more apparent from the following description when read in conjunction with the accompanying figures, which are not intended to limit the scope of the present disclosure.

### SUMMARY

The present disclosure envisages a portable alerting system, for detecting potential threat and alerting users. The system comprises a repository to store predetermined set of rules, predetermined parameters and predetermined audio frequency range. A system processor to provide processing commands A camera to take plurality of pictures, a microphone to record sound, an image processing module to recognize moving objects over plurality of images and to estimate parameters (distance , velocity etc.) with respect to moving object, an audio processing module configured to determine sound similar to predetermined sounds like horn, siren etc. and alerting device to alert the user with respect to detected threats.

### BRIEF DESCRIPTION OF ACCOMPANYING DRAWINGS

The portable alerting system and method of the present disclosure will now be described with the help of accompanying drawings, in which:

FIG. 1 illustrates a schematic diagram for a portable alerting system, in accordance with present disclosure.

FIG. 2 illustrates a flow diagram showing the steps involved in detecting potential threats and alerting users, in accordance with present disclosure

FIG. 3 illustrates an exemplary embodiment of a headphone assembly, in accordance with the present disclosure;

FIG. 4 illustrates an exemplary embodiment of an ear-bud assembly, in accordance with the present disclosure;

FIG. 5 illustrates a flowchart showing the steps involved for alerting a user using a camera 301 based headphone assembly 310 as illustrated in FIG. 3, in accordance with the present disclosure;

FIG. 6 illustrates a flowchart showing the steps involved for alerting a user using a microphone 302 based headphone assembly 310 as illustrated in FIG. 3, in accordance with the present disclosure;

FIG. 7 illustrates an open source hardware board of a system, in accordance with the present disclosure;

FIG. 8 illustrates an exemplary embodiment of a system, in accordance with the present disclosure; and

FIG. 9 illustrates another exemplary embodiment of a system, in accordance with the present disclosure.

### DETAILED DESCRIPTION OF THE ACCOMPANYING DRAWINGS

The portable alerting system and method of the present disclosure will now be described with reference to the embodiment shown in the accompanying drawing. The embodiment does not limit the scope and ambit of the disclosure. The description relates purely to the examples and preferred embodiments of the disclosed system and its suggested applications.

The system herein and the various features and advantageous details thereof are explained with reference to the non-limiting embodiments in the following description. Descriptions of well-known parameters and processing techniques are omitted so as to not unnecessarily obscure the embodiment herein. The examples used herein are intended merely to facilitate an understanding of ways in which the embodiment herein may be practiced and to further enable those of skill in the art to practice the embodiment herein. Accordingly, the examples should not be construed as limiting the scope of the embodiment herein.

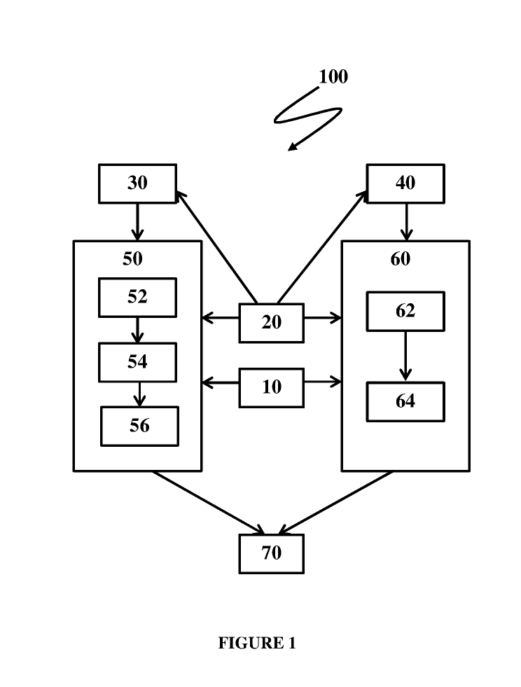

FIG. 1 illustrates a system 100 for a portable alerting system. The system 100 comprises a repository 10, a system processor 20, at least a camera 30, at least a microphone 40, an image processing module 50, an audio processing module 60 and alerting device 70.

The repository 10 is configured to store threshold values corresponding to pre-determined parameters, predetermined set of rules and predetermined audio frequency range.

The system processor 20 is cooperating with the system processor to receive said predetermined set of rules and possessing functional elements to provide system 100 processing commands

The Camera 30 is cooperating with system processor 20 for taking processing commands to capture plurality of images of surrounding. The camera 30 is cooperating with a first transmitter (not shown in figure) to transmit said plurality of captured images.

In an embodiment the camera 30 is configured to capture images at the preferred range of 24 to 30 images per second.

In another embodiment more than one camera is incorporated for capturing images from all directions.

The microphone 40 is cooperating with the system processor 20 for taking processing commands to capture sound from the surrounding. The microphone 40 captures a sound and converts it in to an auditory signal. The microphone 40 is cooperating with a second transmitter (not shown in figure) to transmit the auditory signal.

The image processing module 50 is configured to processing images and determines parameters like distance, velocity and trajectory of the moving object with respect to the user. The image processing module 50 comprises: an image recognizer 52, an estimator 54 and an image comparator 56.

The image recognizer 52 cooperates with the camera 30 to receive plurality of captured images. The image recognizer 52 processes said plurality of captured images and recognize the moving object in said plurality of processed images. The estimator 54 cooperates with the image estimator 52 and configured to estimate values for parameters (distance, velocity and trajectory) of recognized moving object.

The image comparator 56 is cooperating with the estimator 54 to receive estimated values of parameters with respect to the moving object. The image comparator 56 is configured to compare estimated values of parameters with the threshold values of corresponding parameters. If the estimated value of parameters exceeds the threshold values, then image comparator module generates an alert response.

The audio processing module 60 is cooperating with the system processor 20 to receive the system processing commands The audio processing model is also cooperating with the repository to receive predetermined audio frequency range and also with the second transmitter (not shown in figure).

The audio processing module 60 comprises: an audio frequency determiner 62 and an audio analyzer 64. The audio frequency determiner 62 is configured to determine audio frequency of said received auditory signal.

The audio analyzer 64 is cooperating with the audio frequency determiner 62 to receive the determined audio frequency of said auditory signal. Further audio analyzer 64 analyzes, whether the determined audio frequency of said auditory signal lies within the predetermined audio frequency range, if it lies in predetermined range, audio analyzer 64 generates an alert response.

The alerting device 70 is cooperating with image processing module 850 and audio processing module 60 to receive alert response. The alerting device alerts the user by the means of voice alert, vibration alert and visual alert.

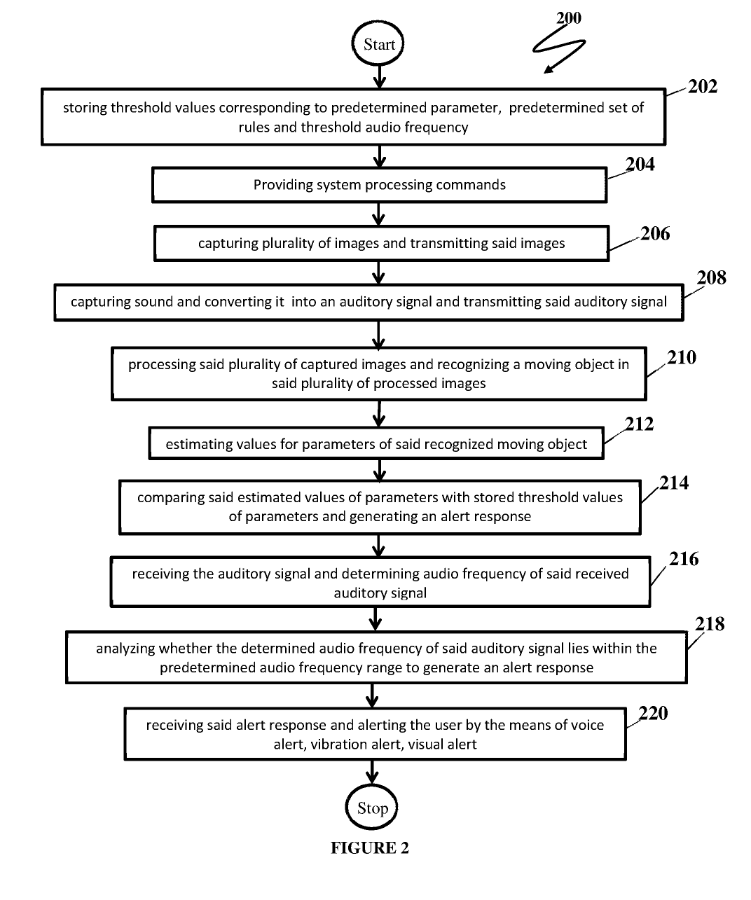

Referring to FIG. 2, illustrates a flow diagram 200 for detecting potential threats and alerting users.

In step 202, threshold values corresponding to predetermined parameter, predetermined set of rules and threshold audio frequency is stored.

In step 204, predetermined set of rules is received and system processing commands have been provided by the system processor.

In step 206, plurality of images is captured under the influence of system processing commands, and said captured images is transmitted.

In step 208, sound is captured from the surrounding and the captured sound is converted into the auditory signal.

In step 210, said captured images are processed and moving objects are recognized in said plurality of processed images.

In step 212, values for parameters (distance, velocity and trajectory) is estimated for recognized moving objects

In step 214, estimated values of parameters (distance, velocity and trajectory) is compared with stored threshold values of parameters and generating an alert response if estimated parameter values exceeds the threshold value.

In step 216, auditory signal is received at audio frequency determiner and audio frequency is measured with respect to received auditory signal.

In step 218, the determined audio frequency of said auditory signal is analyzed with respect to predetermined audio frequency range. If determined audio frequency lies within the predetermined audio frequency range, an alert response is generated.

In step 220, said alert response is received at alerting device, the alerting device alerts the user by the means of voice alert, vibration alert and visual alert and the combination thereof.

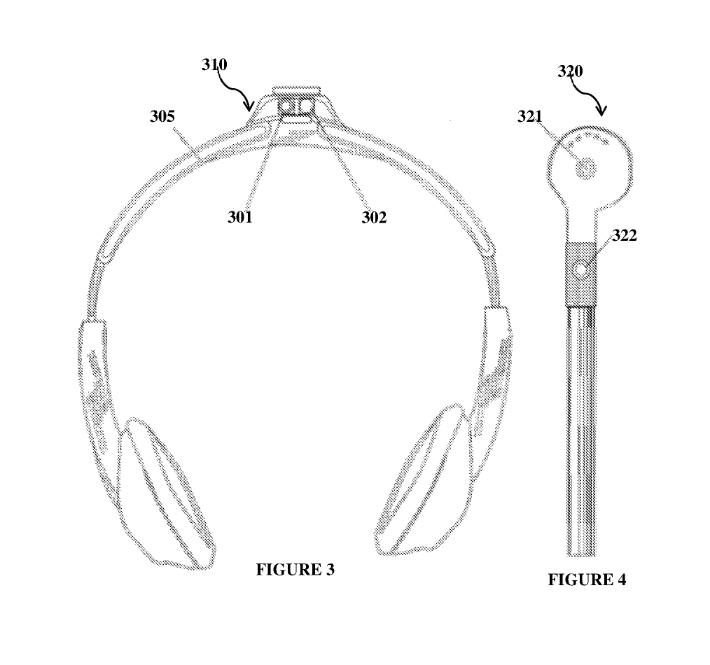

Referring to FIG. 3, illustrates an exemplary embodiment wherein a headphone assembly 310 capable of recognizing the surroundings is connected with a handheld device (not shown in the figure) accessed by a user. The headphone assembly may include at least one camera 301, a microphone 302 mounted on the bridge 305 of the headphone assembly 310, a processor (not shown in figure), a repository (not shown in fig) to store predetermined set of rules. The processor executes the predetermined set of rules to generate processing commands, for the purpose of alerting the user from moving objects or about surrounding sounds to indicate a danger, while they are using the headphone assembly 310 for listening music files or for conversing with other users by accessing their respective handheld device. In an embodiment, the processor and the repository can be incorporated within the headphone assembly 310. In another embodiment, an external processor can be incorporated for fulfilling the processing needs wherein the processor of handheld devices can be used as external processor. It should be understood that the present embodiments may be incorporated into the existing handheld device such as a smartphone to execute the system and method illustrated herein through OEM materials.

FIG. 4 illustrates an ear-bud assembly 320 for recognizing the surrounding sounds. The ear-bud assembly 320 may be connected with the handheld device (not shown in the figure) accessed by a user. Once the ear-bud assembly is connected with the handheld device, it is capable of recognizing the surrounding sounds. The ear-bud assembly 320 comprises a plurality of ear-lobes, each having a protruded bud that can be inserted inside the ear of the user. The ear-bud assembly may incorporate at least a camera 321 mounted on each of the ear-lobes, at least a microphone 322. The camera 321 of the ear-bud assembly 320 is configured in such a manner so that it may able to achieve blind spot coverage. The microphone 322 is incorporated in the lower part of the ear-bud assembly 320. The ear-bud assembly 320 connected with the handheld device, enabled to access the processor of the handheld device which accesses the program logic having a plurality of computer instructions, is used for the purpose of alerting the user.

In accordance with the present disclosure, there involves two embodiments for analyzing the approaching danger corresponding to a given position of the user. In one embodiment, the user can use a headphone assembly 310 or the ear-bud assembly 320 of FIG. 3 or FIG. 4 which is incorporated with the camera 301/321 respectively, for the purpose of capturing images for identifying moving objects, velocity of the identified moving object, and trajectory of the identified moving objects. In an embodiment of the present disclosure, the velocity or trajectory or any other similar measurement taken, observed or recorded corresponding to the identified moving objects are not precise measurements. Since, the aforementioned measurements are extracted through the observations of certain factors. For example, the system of the present disclosure translates the images into a form through which it may recognize relevant moving objects, the two dimensional nature lends itself to only viewing the steady scaling of the object, and the movement of the relative position on the x-y axis. From these observations, rough estimations and extrapolations may be made concerning the trajectory, velocity, and size of the objects over a plurality of moving frames. It may be imprecise to state the absolute velocity, trajectory, of the object can be actually measured, when in fact, it may only be inferred.

In another embodiment, the user can use a headphone assembly 310 or the ear-bud assembly 320 of FIG. 3 or FIG. 4, which is incorporated with the microphone 302/322 respectively, for the purpose of receiving auditory signals and searching for specific auditory signatures such as a vehicle horn, an emergency alarm, a police siren, or any other sounds which may indicate danger to the user.

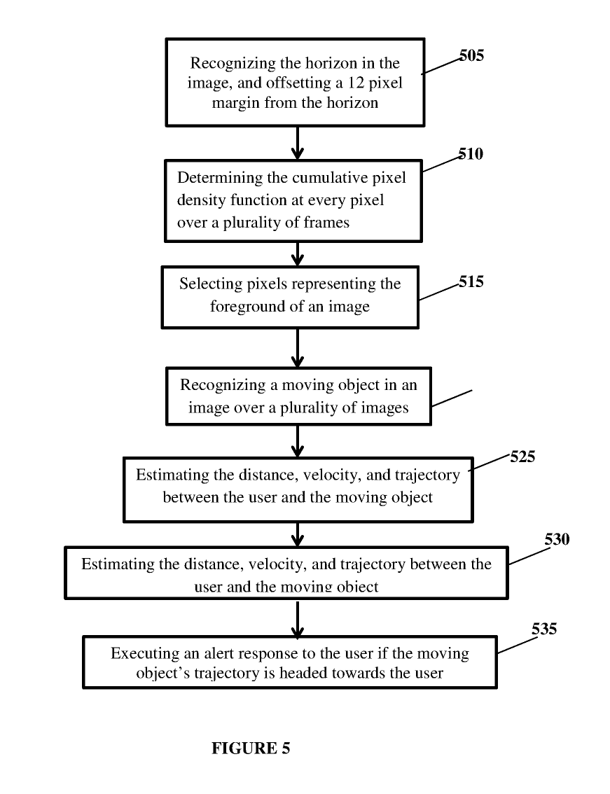

Referring to FIG. 5, illustrates a flowchart showing the steps involved for alerting the user, using camera 301 for detecting various dangers/threats to the user. The camera 301 is configured to capture images at a preferred range. Typically, the preferred range lies between 24 to 30 images per second.

The flowchart as illustrated in the FIG. 5, of the present disclosure includes the following steps:
recognizing a horizon in image, and offsetting a 12 pixel margin from the recognized horizon; 505
determining accumulative pixel density function at every pixel over a plurality of frames; 510
selecting pixels representing the foreground of the image; 515
identifying at least a moving object in the image over a plurality of images; 520
estimating value of at least a parameter corresponding to distance, velocity, and trajectory between the user and an identified moving object; 525
comparing estimated value of the parameters with the stored threshold values corresponding to parameter; 530
executing an alert response to the user if the estimated value of parameter exceeds the threshold value 535.

In accordance with present disclosure step 505 to 520 is performed by image recognizer 52 (shown in FIG. 1). The step of recognizing at least a horizon in the image and offsetting the 12 pixel margin from the recognized horizon, further includes the step of reducing the recognized horizon by 20%, so that more granular horizon may be extrapolated resulting in accurate assessment.

In accordance with the present disclosure, the step of determining the cumulative pixel density function at every pixel over a plurality of images further includes the step of processing by a processor the recognized horizon for identifying the foreground from the background of the horizon. According to one embodiment, this step is achieved through Gaussian probability density function (PDF). Through the use of the Gaussian formula, the processor tries to discern the foreground from the balance of the image. Typically, a pixel corresponding to the identified foreground can be classified as a foreground pixel only if it satisfies the inequality represented in the below mentioned equation (e) 1:

|I(t)−μ(t)|>σ(t) e(1)

where μ(t) represents the mean values; and

σ(t) represents the standard deviation values of the Gaussian PDF respectively.

In accordance with present disclosure, the step of recognizing at least a moving object in the image over the plurality of images further includes the step of processing by the processor to find areas or regions which appear to have a unified constitution. According to an embodiment, this step is achieved through the application of the Laplacian of Gaussian Operator (LoG) function. The LoG function is enabled to extract black and white pixels from the selected images. In addition, the step of processing the selected images further includes the step of separating the black pixels from the white pixels and subsequently tracing the white pixels through the following image feed.

The step of recognizing the moving objects may include the step of filtering the following parameters:
I. size of the object measured in pixels; and
II. height to width ratio of the object.

In an embodiment, the step of filtering the aforementioned parameters, the minimum value corresponding to the size of the object ranges between 50 to 500 pixels, depending upon the resolution of the received images. Further, the step of filtering the parameter corresponding to the height to width ratio of the object includes strict observation of the height and width of the identified moving object. It has been observed that the moving objects are constrained by various height-to-width ratios, wherein the moving objects relate to vehicles. The widths of moving objects are constrained by the narrow streets or thoroughfares of a physical region. Further, it has been observed that many a time the heights of moving objects are constrained in part by overpass bridges, ceilings and the like.

In accordance with the present disclosure step 525 is performed by the estimator 54 (shown in FIG. 1). The step of estimating at least a parameter corresponding to distance, velocity, and trajectory between the user and an identified moving object further narrowed with respect to threshold values for the purpose of triggering of the step of executing the alert responses which are reserved for only the most exigent circumstances.

In accordance with the present disclosure step 530 and 535 is performed by the image comparator 56 (shown in FIG. 1). The step of executing at least an alert response to the user if estimated value of parameter exceeds the threshold value further includes the step of transmitting alert responses if the identified moving object's trajectory is headed towards the user. According to one of the embodiment, an auditory alert response is relayed to the user through the headphone assembly 310 upon receiving the alert response to a visual impaired user. In addition, the step of transmitting alert responses to the user may include the step of transmitting an alert response through a communication network to an emergency response team in an event where the user is impacted by the identified moving object. According to another embodiment, the alert response is relayed through a vibrating mechanism or a lighting mechanism for a hearing impaired user.

In accordance with an embodiment of the system of the present disclosure, the portable alerting system may be incorporated in an Mp3 player installed with a music-playing software is acting as alerting device 70. The processor of the Mp3 player may execute a mute instruction to stop the music-playing software from playing any music, in order to transmit the alert response to the user. Once the system of the present disclosure determines that the identified moving object has exited from the selected frame, or has fallen out of the pre-determined threshold parameters, only then the system will allow the music-playing software resume and continue to play music. In another embodiment an auditory alerting response is generated to warn the user about the direction from which the identified moving object is approaching.

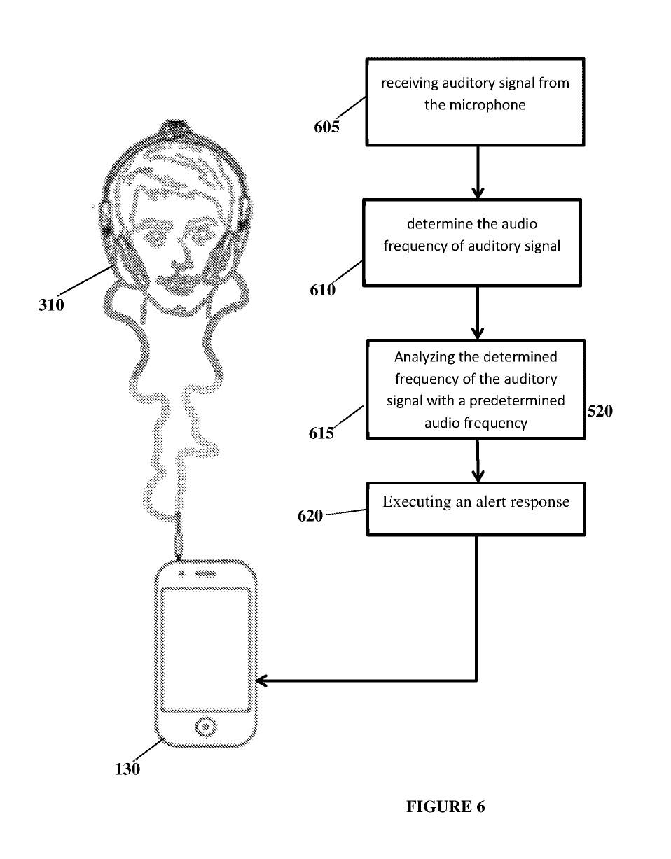

FIG. 6 illustrates a flowchart showing steps involve for alerting the user using the microphone 302 configured in headphone assembly 310, as illustrated in FIG. 3 for detecting various dangers when a user is listening to music, or is conversing using the headphone assembly 310 connected with the handheld device. There is shown the headphone assembly 310 used by the user, wherein the headphone assembly 310 is connected with the handheld device 330. The computer instructions pertaining to the system of the present disclosure are installed and stored into a memory of the handheld device 330. The second flowchart as illustrated in the FIG. 6 of the present disclosure includes the following steps:
receiving auditory signal from the microphone 302; 605
determine the audio frequency of auditory signal; 610
analyzing the determined frequency of the auditory signal with respect to predetermined audio frequency range; 615 and, if matches, executing and generating the alert response for the user to indicate danger; 620.

In accordance with the present disclosure, the step of receiving auditory signal from the microphone 302 further includes the step of receiving the auditory signal 610. The step of determining the audio frequency of auditory signal further includes the step of converting determined audio frequency of auditory signal from amplitude v. time domain to amplitude vs. frequency domain. This conversion is accomplished through the application of the Fast Fourier Transform (FFT) algorithm.

In accordance with the present disclosure, the step of analyzing the determined frequency of the auditory signal with respect to predetermined audio frequency range further includes the step of applying a differentiator in order to filter and recognize the responses like electronic signal related to sound acoustic signatures of interest, such as a siren or the horn of a train based upon its inherent frequency. The system of the present disclosure is provided with an access to a plurality of acoustic signatures, sounds, electronic signal related to sound/noise and the like. The system continuously monitors for the detection of any similar surrounding sound in the backdrop.

In accordance with the present disclosure, the step of executing and generating the alert response for the user to indicate danger further includes the step of applying mute computer instruction to the music-play software playing the music or terminating the on-going conversation of the user using the headphone assembly 310 connected with the handheld device for the purpose of generating alert responses to indicate the approaching danger.

The target frequency range for horns received from the transporting vehicles such as trains, trucks, cards is between 300 Hz to 700 Hz. The predetermined audio frequency of the ideal alert response may range between 300 Hz to 700 Hz. In one of the embodiments of the present disclosure, information pertaining to Doppler's function may be incorporated to determine the Doppler's effect. This enables the system to generate alert responses for the user to indicate whether the identified moving object is approaching or moving away from the user. Further, this enables the system to reduce the number of false alert responses generated for the user.

In accordance with an alternative embodiment of the FIG. 6 of the present disclosure, the flowchart may involve steps for alerting the user using the microphone 322 based ear-bud assembly 320 as illustrated in FIG. 4 for detecting various dangers/threats to the user.

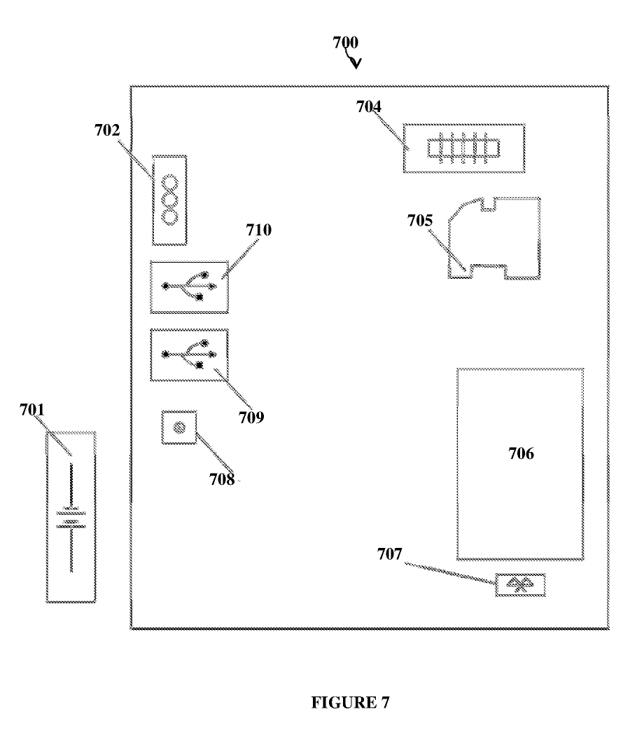

FIG. 7 illustrates an open source hardware board of a system 700 which, in various implementations of an embodiment, may be used in conjunction with, but not limited to the embodiments described herein. The system 700 in one of the embodiment includes a power source 701, a CCD/CMOS camera 704, a memory card 705, a processor 706, a Bluetooth transceiver 707, a power port 708, a microphone 702, at least one USB ports (709 and 710)—all integrated in order to operate aspects of the embodiments described and illustrated above. Typically, the system 700 is shown as an open source printed circuit board which is used for interlinking hardware components and enabling the hardware components to perform the required functionalities. The power source 701 is connected to the power port 708. Typically, the power source 701 may be a battery. Once, the system 700 is in active state, the processor 706 is enabled to execute the program instructions stored in the memory card 505 for initiating the microphone 702 and CCD/CMOS camera 704 for the purpose of receiving an input signal having a sound data and an image data. Further, the processor 706 is enabled to process the input signal and determine the possible dangers for the user. If any danger is found while analyzing the input signal, the processor is enabled to generate alerts for the user. The system 700 assists in warning the user of the incoming danger or threats. The Bluetooth transceiver 707 and USB ports (709 and 710) of the system 700 are used for interfacing with other electronic devices.

FIG. 8 illustrates a first exemplary embodiment of a system, in the exemplary scenario 800, a user 820 listening to music or conversing using a headphone assembly 810 connected with a handheld device (not shown in the figure). The system is installed and executed on the handheld device accessed by the user 820. In the aforementioned scenario 800 it is assumed that the user 820 is crossing a railway track (not shown in the figure) without paying much attention to the approaching train 815 from the hind-side of the user. As the user 820 is busy in listening music or conversing, when the train 815 blows a horn, microphone (not shown in the figure) mounted on the headphone assembly 810 receives the auditory alert response from the train 815 i.e. the horn blown by the train 815. Automatically, once the microphone captures the auditory alerts responses from the train 815, the system processes the auditory alerts responses and compares the received auditory alerts response frequency with respect to a predetermined auditory alerts responses frequency stored in a repository. The system is enabled to access a plurality of acoustic signatures, sounds, etc. stored into the repository, represents the panic situation. If the received auditory alert responses match with the predetermined auditory alert responses, the system executes and generates alert responses for the user to indicate the approaching danger in the form of an alert warning. In addition, the system is enabled to stop the music or conversation, or vibration alert initially accessed by the user.

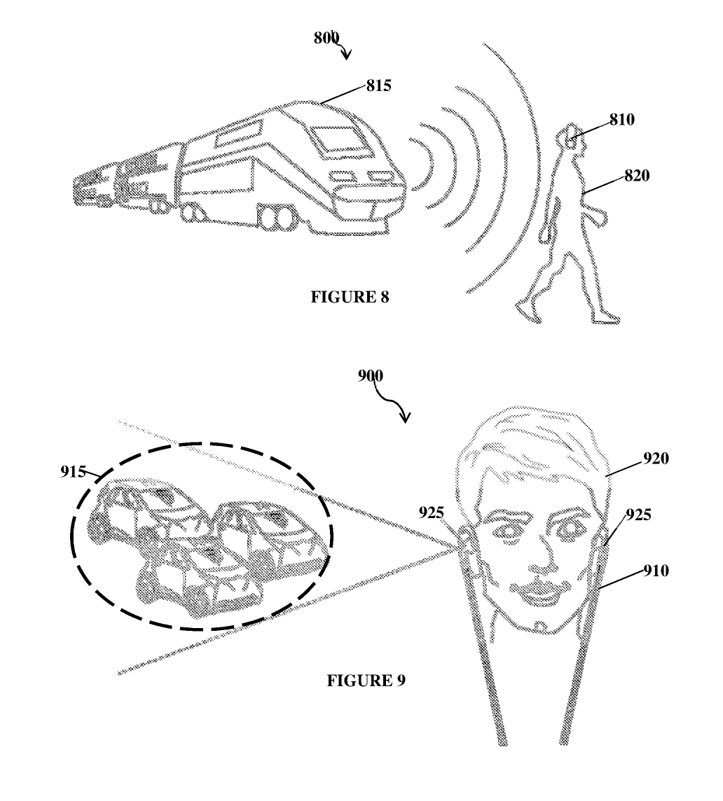

FIG. 9 illustrates a exemplary embodiment of a system 900, in which a user 920 is listening to the music or conversing using an ear-bud assembly 910 used by the user 920. In the aforementioned scenario 900 it is assumed that the user 920 is walking on a busy road without paying much attention to the moving objects such as vehicles or automobiles or cars. A group of objects 915 identified as cars moving towards the user 920. The cameras 925 mounted on the ear-bud assembly 910 captures a plurality of images. These are received by the system of the present disclosure and processed to determine a danger/threat to the user. The system detects and determines the movements of the identified objects in the images captured by the cameras 925 with respect to the user 920. In addition, the system is enabled to infer other data like trajectory, velocity and relative size of the identified moving objects in the images. Based on this data the system is configured to execute and generate alert responses for the user if the moving object's trajectory is headed towards the user to indicate danger.

### TECHNICAL ADVANCEMENTS

The technical advancements offered by the portable alerting system and method thereof of the present disclosure include the realization of:
a system that alerts a user from moving objects;
a system that alerts a user by detecting the sounds of the moving objects, which may indicate menace;
a system that alerts a blind user from moving objects or sounds which may indicate menace;
a system that alerts a deaf user from moving objects or sounds which may indicate menace; and
a system that allows a user to move securely using a handheld device equipped with a headphone in crowded places.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A portable alerting system, for detecting potential threats and alerting users against said threats, said system comprising:
a repository configured to store threshold values corresponding to predetermined parameter, predetermined set of rules and predetermined audio frequency range;
a system processor cooperating with the repository to receive said rules and possessing functional elements to provide system processing commands;
at least a camera cooperating with the system processor and configured to capture plurality of images under influence of the system processing commands, said camera cooperating with a first transmitter to transmit said plurality of captured images;
at least a microphone cooperating with the system processor and configured to capture sound under influence of the system processing commands and convert the captured sound into an auditory signal, said microphone cooperating with a second transmitter to transmit said auditory signal;
an image processing module cooperating with said system processor to receive said system processing commands, said repository to receive said threshold values corresponding to predetermined parameter and said first transmitter to receive said plurality of captured images, said image processing module comprising:
an image recognizer configured to process said plurality of captured images and recognize a moving object in said plurality of processed images;
an estimator cooperating with said image recognizer and configured to estimate values for parameters of said recognized moving object; and
an image comparator configured to compare said estimated values of parameters with said stored threshold values of corresponding parameters and generate an alert response if said estimated values of parameters exceed said threshold values;
an audio processing module cooperating with said system processor to receive said system processing commands, said repository to receive said predetermined audio signal and said predetermined audio frequency range and said second transmitter to receive auditory signal, said audio processor module comprising:
an audio frequency determiner configured to determine the audio frequency of said received auditory signal; and
an audio analyzer cooperating with said audio frequency determiner and configured to analyze whether the determined audio frequency of said auditory signal lies within the predetermined audio frequency range to generate an alert response;
an alerting device cooperating with the system processor, the image processing module and the audio processing module to receive said alert response and configured to alert the user.

2. The system as claimed in claim 1, wherein the camera is taking images at the range of 24-30 images per second.

3. The system as claimed in claim 1, wherein estimated parameters are selected from the group consisting of distance, velocity, trajectory and combination thereof.

4. The system as claimed in claim 1, wherein user is alerted by the means of voice alert, vibration alert, visual alert and combination thereof.

5. A portable alerting method, for detecting potential threats and alerting users against said threats, said method comprising:
storing threshold values corresponding to predetermined parameter, predetermined set of rules, predetermined audio signal and predetermined audio frequency range;
receiving predetermined set of rules and providing system processing commands;
capturing plurality of images and transmitting said plurality of captured images;
capturing sound and converting the captured sound into an auditory signal and transmit said auditory signal;
processing said plurality of captured images and recognizing a moving object in said plurality of processed images;
estimating values for parameters of said recognized moving object;
comparing said estimated values of parameters with said stored threshold values of corresponding parameters and generating an alert response if said estimated values of parameters exceed said threshold values
receiving the auditory signal and determining audio frequency of said received auditory signal
analyzing whether the determined audio frequency of said auditory signal lies within the predetermined audio frequency range to generate an alert response;
receiving said alert response and alerting the user by the means of voice alert, vibration alert, visual alert and combination thereof.
